(19) United States
(12) Patent Application Publication
(10) Pub. No.: US 2015/0251950 A1
(43) Pub. Date: Sep. 10, 2015

(54) COATING METHOD WITH SILICA COATING, AND SILICA-COATED BODY AND PRODUCTION METHOD THEREFOR

(71) Applicant: Shin-Etsu Quartz Products Co., Ltd., Tokyo (JP)

(72) Inventors: Hiroyuki WATANABE, Koriyama-shi (JP); Tatsuhiro SATO, Koriyama-shi (JP); Takayuki IMAIZUMI, Koriyama-shi (JP)

(21) Appl. No.: 14/622,128

(22) Filed: Feb. 13, 2015

Related U.S. Application Data
(60) Provisional application No. 61/940,570, filed on Feb. 17, 2014.

(51) Int. Cl. C03C 17/02; B05D 3/00

(52) U.S. Cl. CPC C03C 17/02; B05D 3/007; C03C 2217/213; C03C 2217/70

(57) ABSTRACT

A coating method for a base material, including forming a silica coating having a desired and uniform thickness on the surface of the base material. A silica-coated body allowing the silica coating to sufficiently function as a reflective coating for ultraviolet rays to infrared rays even when the silica coating has a smaller thickness than those in the related art. A coating method for a surface of a base material with a silica coating, the method including at least: adding silica glass particles and an organic material capable of gelling by a thermal factor in an aqueous solution to water to produce a slurry; applying the slurry onto the surface of the base material to form an applied coating, followed by subjecting the applied coating to thermal treatment, to thereby obtain a gel coating; drying the gel coating to provide a silica particle layer; and heating the silica particle layer to fix the silica particle layer onto the surface of the base material, to thereby provide a silica coating.

### CROSS REFERENCE TO RELATED APPLICATIONS

This application claims the benefit of priority of U.S. provisional patent application Ser. No. 61/940,570 filed Feb. 17, 2014, the entire contents of which are incorporated herein by reference.

### BACKGROUND OF THE INVENTION

1. Field of the Invention

The present invention relates to a coating method for a surface of a base material with a silica coating. The present invention also relates to a silica-coated body coated with a silica coating, and a production method therefor.

2. Description of the Related Art

For various purposes, a surface of a base material has been coated with a silica glass coating. In particular, a method of coating a surface of a base material of silica glass (quartz glass) with a silica coating has been widely conducted.

When the silica glass is subjected to grinding processing, its surface loses smoothness and transparency. Therefore, polishing is performed on the surface of the silica glass to recover the smoothness and transparency. In addition, in the case where the polishing is difficult, for example, where the silica glass has a complex three-dimensional shape, such as a method for heating its surface with flame has been also conducted. However, those methods take time for an operation or removal of glass strain. Therefore, a method for coating the surface of silica glass with a silica coating has been also conducted.

As the silica coating for coating a surface of a base material, a silica coating in a form in which silica particles are deposited has been known (Patent Documents 1 and 2). Such silica coating in a form in which silica particles are deposited has excellent shielding properties in a wide range of from ultraviolet rays to infrared rays, and hence, is formed on, for example, inner and outer surfaces of a quartz tube, to be used. In such formation of a coating on an outer surface of a quartz tube, various methods such as spray coating or dip coating can be applied. On the other hand, in the formation of a coating on an inner surface of a tube, a slurry obtained through addition of a high-viscosity liquid, a binder, or the like is used. However, in the formation of a silica coating on an inner surface of a tube, for example, in the case of a tube having a small inner diameter or a long tube, there are problems in that: although the silica particles are dispersed in a high-viscosity liquid, the formed silica coating has a non-uniform thickness owing to dripping after application; and it is difficult to achieve a desired thickness. In addition, such problem of dripping after application of a slurry is not limited to application on an inner wall of a tubular base material.

In addition, the silica coatings in a form in which silica particles are deposited disclosed in Patent Documents 1 and 2 each have a purpose of reflecting light. In order to obtain a high reflectance, the silica coating is required to have a large thickness.

In addition, as a method of producing a silica glass product, there has been known a method involving injection molding a slurry obtained by mixing silica powder, a cellulose derivative, and water, to produce a silica glass product (Patent Documents 3 and 4).

### PRIOR ART DOCUMENTS

### Patent Documents

Patent Document 1: JP 2009-146588 A
Patent Document 2: JP 2008-510676 A
Patent Document 3: JP 2006-321691 A
Patent Document 4: WO2006/085591A

As described above, in the formation of a silica coating on a surface of a base material using a slurry, there are problems in that the formed silica coating has a non-uniform thickness owing to dripping of the slurry after its application and it is difficult to achieve a desired thickness.

### SUMMARY OF THE INVENTION

The present invention has been made in view of the foregoing problems, and thus, an object of the present invention is to provide a coating method for a base material, including forming a silica coating having a desired and uniform thickness on the surface of the base material.

Another object of the present invention is to provide a silica-coated body allowing the silica coating to sufficiently function as a reflective coating for ultraviolet rays to infrared rays even when the silica coating has a smaller thickness than those in the related art.

According to the present invention, which has been made in order to achieve the above-mentioned objects, there is provided a coating method for a surface of a base material with a silica coating, the method including at least:

adding silica glass particles and an organic material capable of gelling by a thermal factor in an aqueous solution to water to produce a slurry;

applying the slurry onto the surface of the base material to form an applied coating, followed by subjecting the applied coating to thermal treatment, to thereby obtain a gel coating;

drying the gel coating to provide a silica particle layer; and

heating the silica particle layer to fix the layer onto the surface of the base material, to thereby provide a silica coating.

According to the coating method with a silica coating, dripping of the slurry can be prevented by allowing the slurry to be gelled through thermal treatment and significantly reducing its flowability. Thus, the silica particle layer can be easily controlled to have a desired thickness. As a result, the surface of the base material can be coated with the silica coating having a desired and uniform thickness after the heating. In addition, the formed silica coating can be a silica coating in which the silica glass particles are each immobilized with its particulate form remaining.

In this case, a material of the base material may include silica glass. In addition, a material of the base material may include black silica glass. The black silica glass is preferably black synthetic silica glass.

The coating method with a silica coating according to the present invention is particularly suitable for coating the surface of silica glass, which is the same kind of material as the silica coating to be formed.

In addition, the organic material capable of gelling by a thermal factor preferably includes methyl cellulose. Alternatively, the organic material capable of gelling by a thermal factor preferably includes agar.

Such organic materials are inexpensive, and besides, using such organic materials facilitates gelation of the slurry by a thermal factor (heating or cooling).

In addition, the silica glass particles to be contained in the slurry preferably have an average particle size of from 5 nm to 5 μm.

By using the silica glass particles having such average particle size, the slurry can have a more uniform thickness.

In addition, in the coating method with a silica coating according to the present invention, when the base material has a tubular shape, the silica coating may be formed on an inner wall of the tubular base material.

Even when the silica coating is formed on the inner wall of the tubular base material as just described, the silica coating having a desired and uniform thickness can be formed on the inner wall of the tubular base material according to the coating method with a silica coating of the present invention.

In addition, the coating method with a silica coating according to the present invention may further include heating the silica coating formed on the surface of the base material to make at least a surface portion of the silica coating transparent, to thereby provide a transparent silica glass layer.

When at least a surface portion of the silica coating formed on the surface of the base material is made transparent through heating to provide the transparent silica glass layer as just described, generation of particles or emission of impurity gas molecules from the silica coating can be more effectively prevented.

In this case, the surface portion of the silica coating to be served as the transparent silica glass layer may include a region from a surface to a depth of at least 0.05 mm.

When the region up to such depth is made transparent, generation of particles or emission of impurity gas molecules can be sufficiently prevented.

In addition, the heating may be performed so that an entirety of the silica coating is made transparent, to thereby provide the transparent silica glass layer. In addition, the silica coating formed on the surface of the base material may be a non-transparent silica glass layer.

According to the coating method with a silica coating of the present invention, the entirety of the silica coating formed on the surface of the base material may be a transparent silica glass layer, depending on the purpose.

According to the present invention, there is also provided a production method for a silica-coated body, the method including coating the surface of the base material with a silica coating by any one of the above-mentioned coating methods with a silica coating.

According to such production method for a silica-coated body, a silica particle layer can be easily controlled to have a desired thickness, and hence, the silica-coated body in which the surface of the base material is coated with the silica coating having a desired and uniform thickness can be produced.

According to the present invention, there is further provided a silica-coated body, including: a base material; and a silica coating formed on a surface of the base material, in which:
the silica coating includes silica glass particles each having a size of from 50 nm to 300 nm at a density of 9×10¹² particles/cm³ or more; and
the silica coating has an absolute diffuse light reflectance of 30% or more in a wavelength range of from 200 nm to 5,000 nm.

Such silica-coated body in which a number of silica glass particles are immobilized as the silica coating on the surface of the base material allows the silica coating to function as a reflective coating for ultraviolet rays to infrared rays, even when the silica coating has a smaller thickness than those in the related art.

In this case, a material of the base material may include silica glass. In addition, a material of the base material may include black silica glass. The black silica glass is preferably black synthetic silica glass.

It is preferred that the black silica glass has a light transmittance of 10% or less in a range of from 200 to 10,000 nm at a thickness of 1 mm, a total concentration of metal impurities of 1 ppm or less, a carbon concentration of more than 30 ppm and 50,000 ppm or less, an OH group concentration of 1 ppm or less, and a viscosity of 10^{11.7} poise or more at 1,280° C.

As described above, when the base material including silica glass is coated with the silica coating of the present invention and uses the silica coating as a reflective coating, the silica-coated body can be widely applied to various purposes.

In addition, the silica coating preferably has a thickness of 0.5 mm or more.

When the silica coating has such thickness, the silica coating can sufficiently function as a reflective coating for ultraviolet rays to infrared rays.

In addition, the silica coating preferably has a total number of molecules of desorption gas up to 1,000° C. in terms of hydrogen, water, oxygen, and carbon dioxide of 1×10²³ molecules/g or less.

When the silica coating has such total number of molecules of desorption gas, an adverse effect caused by gas molecules emitted from the silica coating can be reduced in using the silica-coated body.

In addition, the silica coating preferably has a transparent silica glass layer in the surface thereof. In this case, the transparent silica glass layer preferably has a thickness of 0.05 mm or more.

As just described, when the silica-coated body includes the transparent silica glass layer in the surface of the silica coating, effects of preventing generation of particles or emission of impurity gas molecules from the silica coating, and the like can be obtained. In addition, such effects can be sufficiently obtained when the transparent silica glass layer has a thickness of 0.05 mm or more.

In addition, the transparent silica glass layer preferably has a total number of molecules of desorption gas up to 1,000° C. in terms of hydrogen, water, oxygen, and carbon dioxide of 1×10¹⁵ molecules/g or less.

When the transparent silica glass layer has such total number of molecules of desorption gas, an adverse effect caused by gas molecules emitted from the silica coating can be further reduced in using the silica-coated body.

According to the coating method with a silica coating of the present invention, the surface of the base material can be coated with the silica coating having a desired and uniform thickness. In addition, the formed silica coating can be a silica coating in which the silica glass particles are each immobilized with its particulate form remaining.

In addition, the silica-coated body according to the present invention allows the silica coating to function as a reflective coating for ultraviolet rays to infrared rays, even when the silica coating has a smaller thickness than those in the related art.

### BRIEF DESCRIPTION OF THE DRAWINGS

FIG. 1 is a flow diagram illustrating an outline of a coating method with a silica coating according to a first embodiment of the present invention.

FIG. 2 is a flow diagram illustrating an outline of a coating method with a silica coating according to a second embodiment of the present invention.

FIG. 3 is a schematic sectional view illustrating an example of a silica-coated body according to the present invention.

FIG. 4 is a schematic sectional view illustrating another example of the silica-coated body according to the present invention.

FIG. 5 is a schematic sectional view illustrating still another example of the silica-coated body according to the present invention.

FIG. 6(a) is a SEM photograph of a surface of a silica coating of the present invention.

FIG. 6(b) is a SEM photograph of a cross-section of a silica coating of the present invention.

FIG. 7(a) is a SEM photograph of a surface of a related-art silica coating.

FIG. 7(b) is a SEM photograph of a cross-section of a related-art silica coating.

FIG. 8 is a schematic view illustrating a method of forming a gel coating on the surface of a base material, including dipping the base material into a slurry.

FIG. 9 is a schematic view illustrating a method of pouring a slurry into the inside of a tubular base material.

### DETAILED DESCRIPTION OF THE PREFERRED EMBODIMENTS

In formation of a silica coating on the surface of a base material using a slurry, there are problems in that the formed silica coating has a non-uniform thickness owing to dripping of the slurry after its application and it is difficult to achieve a desired thickness.

The inventors of the present invention have found that the above-mentioned problems can be solved by: adding, to a slurry containing silica glass particles, at least one kind of organic material capable of gelling by a thermal factor; and forming a silica particle layer on a base material through gelation of the slurry. That is, the slurry is gelled by a thermal factor, and hence, has a significantly reduced flowability. Thus, dripping of the slurry can be prevented, and besides, the silica particle layer can be easily controlled to have a desired thickness. The inventors of the present invention have also found that: a silica coating formed by using such slurry can be a silica coating in which the silica glass particles are each immobilized with its particulate form remaining; and the silica coating can sufficiently function as a reflective coating for ultraviolet rays to infrared rays even when the silica coating has a smaller thickness than those in the related art.

Hereinafter, the present invention is described in detail with reference to the drawings. However, the present invention is not limited thereto.

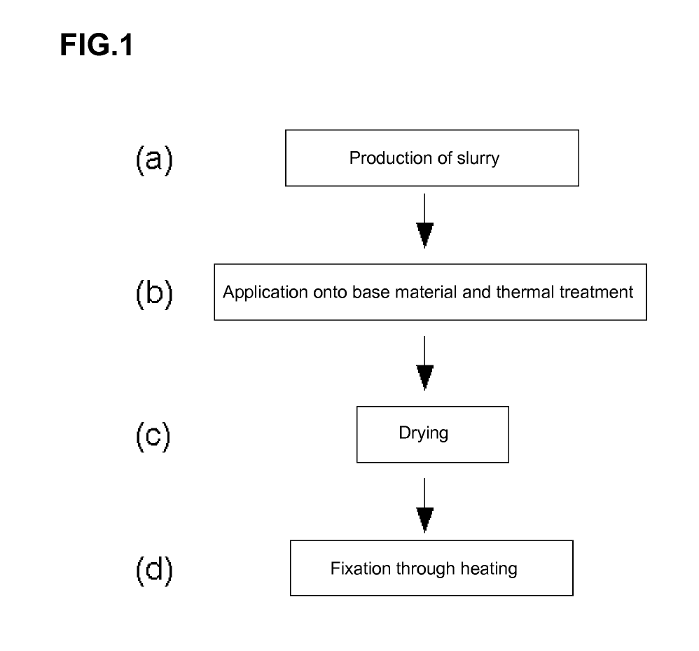

FIG. 1 illustrates an outline of a coating method with a silica coating according to a first embodiment of the present invention.

First, as illustrated by (a) in FIG. 1, silica glass particles and an organic material capable of gelling by a thermal factor in an aqueous solution are added to water, to produce a slurry (step a).

Examples of the organic material capable of gelling by a thermal factor in an aqueous solution include cellulose derivatives and agar. An aqueous solution of a cellulose derivative is gelled through heating, and its flowability is reduced. Of cellulose derivatives, methyl cellulose is particularly preferred because of its high gel strength.

In contrast, an aqueous solution of agar (agarose) is gelled through cooling, and its flowability is reduced. Methyl cellulose and agar are preferred because those substances are inexpensive and facilitate gelation of the slurry by a thermal factor.

In addition, in this case, the silica glass particles to be contained in the slurry preferably have an average particle size of from 5 nm to 5 μm. The silica glass particles each have a particle size within a range of preferably from 1 nm to 10 μm, more preferably from 50 nm to 300 nm. By using such silica glass particles, the slurry can exhibit a more uniform thickness. In addition, as described later, when a silica coating is utilized as a reflective coating, using the silica glass particles each having such particle size is effective for improving a reflectance.

In the slurry, there may be blended, for example, a binder (any one of a water-soluble binder or an emulsion may be used), or a dispersing agent for preventing agglomeration of particles in the slurry, in addition to the foregoing.

Next, as illustrated by (b) in FIG. 1, the slurry is applied onto the surface of a base material to form an applied coating, and the applied coating is subjected to thermal treatment to obtain a gel coating (step b).

As a method of forming the applied coating on the surface of the base material, various known methods such as spray coating, dip coating, brush coating, and coating through pouring may be appropriately used. For example, when the base material has a complex three-dimensional shape, a method involving dipping or the like may be used. In addition, for example, when the base material has a tubular shape and the applied coating is formed on its inner wall, a method involving pouring or the like may be used. Thus, the applied coating can be uniformly formed on the surface of the base material.

The “subjected to thermal treatment” means being subjected to heating or cooling depending on the kind of the organic material capable of gelling by a thermal factor. That is, when a cellulose derivative is adopted as the organic material, its gelation is performed by heating, and when agar is adopted as the organic material, its gelation is performed by cooling. Herein, the gel coating only needs to be obtained, and the specific method for heating or cooling is not particularly limited.

The material of the base material may be silica glass. The coating method with a silica coating of the present invention includes coating the surface of a base material with a silica coating by using silica glass particles. Therefore, the method of the present invention is particularly suitable for the case where also the material of the base material is silica glass from the viewpoints of a coefficient of thermal expansion and the like. Examples of the silica glass as the base material include natural transparent quartz glass, natural or synthetic non-transparent quartz glass with bubbles, black quartz glass, and silica glass in a state of frosted glass (with surface irregularities).

The present invention is particularly suitable for the case where the base material has a tubular shape and the silica coating is formed on the inner wall of the tubular base material. On the inner wall of such tubular base material (for example, a tube made of silica glass) having an inner diameter of, for example, 20 mm or less, a silica coating having a desired and uniform thickness has not been able to be formed heretofore. In the present invention, the silica coating can be formed even on the inner wall of such tubular base material having a small inner diameter. For example, even on the inner wall of a tubular member having an inner diameter of 5 mm, the silica coating having a desired and uniform thickness can be formed.

Next, as illustrated by (c) in FIG. 1, the gel coating is dried to provide a silica particle layer (step c).

A drying method is not particularly limited. For example, the drying may be performed by leaving in dry air. The drying may be performed at room temperature.

Next, as illustrated by (d) in FIG. 1, the silica particle layer is heated to be fixed on the surface of the base material, to thereby provide a silica coating (step d). As a method of heating the silica particle layer to provide the silica coating, any method generally used for heating of glass, using an atmosphere sintering furnace, a vacuum sintering furnace, or the like, may be adopted.

By the sintering step, the silica glass particles are necked with each other, and besides, the silica coating is fixed onto the base material. When the base material is formed of silica glass, the silica coating is particularly well fixed thereonto.

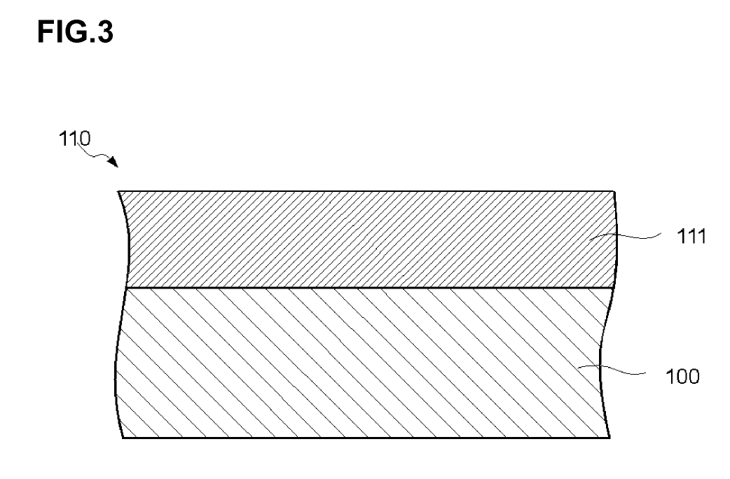

Thus, a silica-coated body 110 as illustrated in FIG. 3 can be obtained. The silica-coated body 110 includes a base material 100 and a silica coating 111 formed on the surface of the base material 100. Further, in the silica coating 111 silica glass particles are each immobilized with its particulate form remaining via the steps a to d. In the immobilized form, while the particles are connected to each other through necking, one particle can be distinguished from another particle by regarding as a boundary an irregularity, bubble, gap, interface, density variation, or the like.

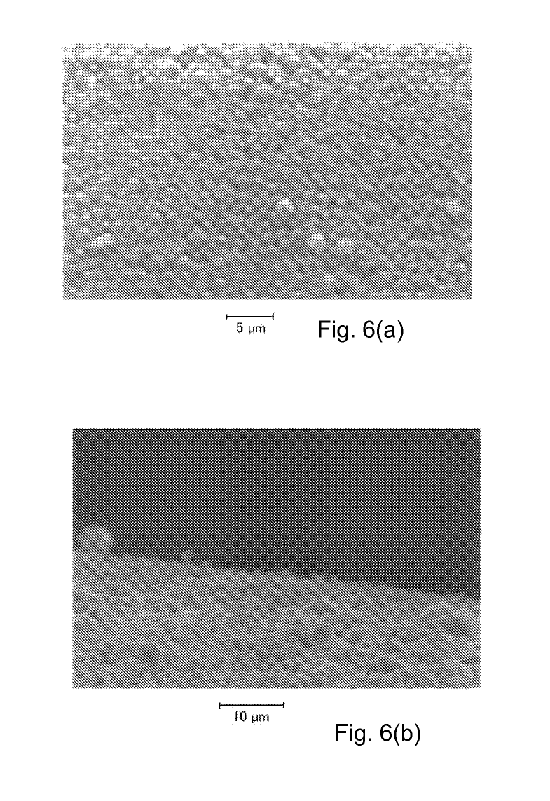

FIG. 6 show scanning electron microscope (SEM) photographs in the case of forming a silica coating on a silica glass plate by the coating method with a silica coating of the present invention. FIG. 6 (a) is a SEM photograph of the surface of the silica coating, and FIG. 6 (b) is a SEM photograph of the cross-section of the silica coating. It is found that the particulate forms of the silica glass particles remain and the particles each have a size falling with a certain range.

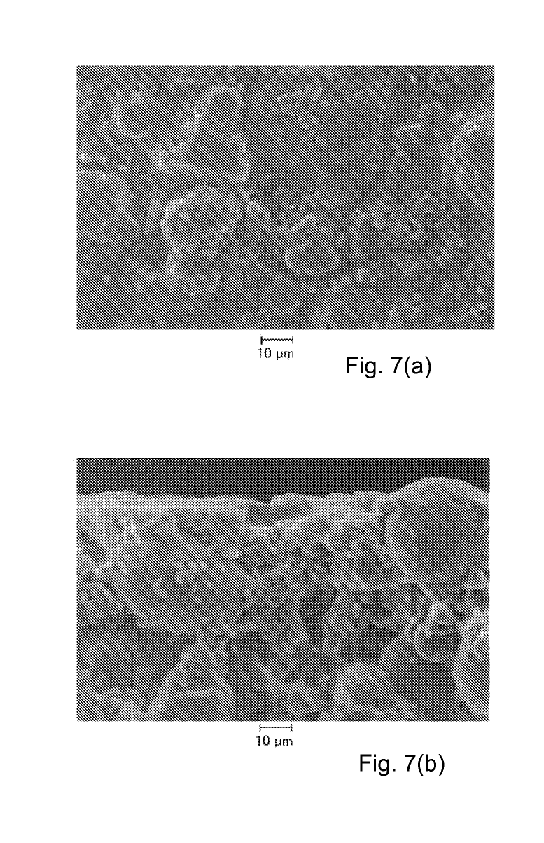

In contrast, FIG. 7 show SEM photographs of a silica coating formed by a related-art method (a method disclosed in Patent Document 2). FIG. 7 (a) is a SEM photograph of the surface of the silica coating, and FIG. 7 (b) is a SEM photograph of the cross-section of the silica coating. Comparison to FIG. 6 reveals that the particulate form of silica hardly remains in FIG. 7.

The thickness of the silica coating can be further increased by repeating the steps b to d. Alternatively, the silica coating having a large thickness can be obtained by repeating the steps b and c to form a silica particle layer having a large thickness, finally followed by heating and fixation in the step d.

The silica glass particles present in the silica coating each have a particle size within a range of preferably from 1 nm to 10 μm, more preferably from 50 nm to 300 nm. Ideally, the silica glass particles are fine and present densely. When the silica glass particles are present at a density of 9×10¹² particles/cm³ or more, the reflectance is effectively improved. According to the coating method with a silica coating of the present invention, the silica coating can include silica glass particles each having a size of from 50 nm to 300 nm at a density of 9×10¹² particles/cm³ or more. This allows the silica coating to have an absolute diffuse light reflectance of 30% or more in a wavelength range of from 200 nm to 5,000 nm.

It should be noted that, when the particle sizes of the silica glass particles to be mixed in the slurry become smaller, it becomes difficult to obtain a desired thickness owing to a low concentration of the slurry. On the other hand, when the particle size becomes larger, the reflectance tends to be reduced. In this connection, the particle sizes of the silica glass particles to be mixed in the slurry are appropriately selected depending on the thickness of the silica coating and a reflectance to be required.

When the silica coating is used as a reflective coating in a wide range of from ultraviolet rays to infrared rays, the silica coating has a thickness of preferably 0.5 mm or more.

There arises a problem of emission of impurities from the silica coating in some applications of the silica-coated body. When the silica-coated body has high temperature, emission of hydrogen, water, oxygen, and carbon dioxide tends to increase. Therefore, with a view to preventing emission of such gases, the heat treatment in the step of providing the silica coating through heating and melt-fixation (step d) is preferably performed in an oxygen-containing atmosphere or a nitrogen atmosphere. When the silica coating has a total number of molecules of desorption gas up to 1,000° C. in terms of hydrogen, water, oxygen, and carbon dioxide of 1×10²³ molecules/g or less, an adverse effect caused by those gases can be suppressed.

The total number of molecules of desorption gas can be measured as described below. Gas to be desorbed is subjected to mass spectrometry and its number of molecules is quantitatively analyzed by a thermal desorption gas analysis method (using a thermal desorption spectrometer WA 1000 S/W manufactured by ESCO, Ltd.). The conditions for the desorption gas analysis in the present invention are described below. A sample to be measured was placed in a reduced-pressure chamber, and the temperature was increased from room temperature up to 1,000° C. at a rate of 30° C./minute under a high vacuum atmosphere. After the temperature reached 1,000° C., the sample was maintained at the temperature for 30 minutes. The number of molecules of each gas having the corresponding molecular weight emitted from the sample from the beginning of the temperature increase from room temperature to the completion of the maintenance at 1,000° C. for 30 minutes was measured. The gases having a molecular weight of 2, 18, 32, and 44 were regarded as hydrogen gas, water, oxygen gas, and carbon dioxide gas, respectively, and the sum total of the numbers of molecules of the gases was regarded as the total number of molecules of desorption gas.

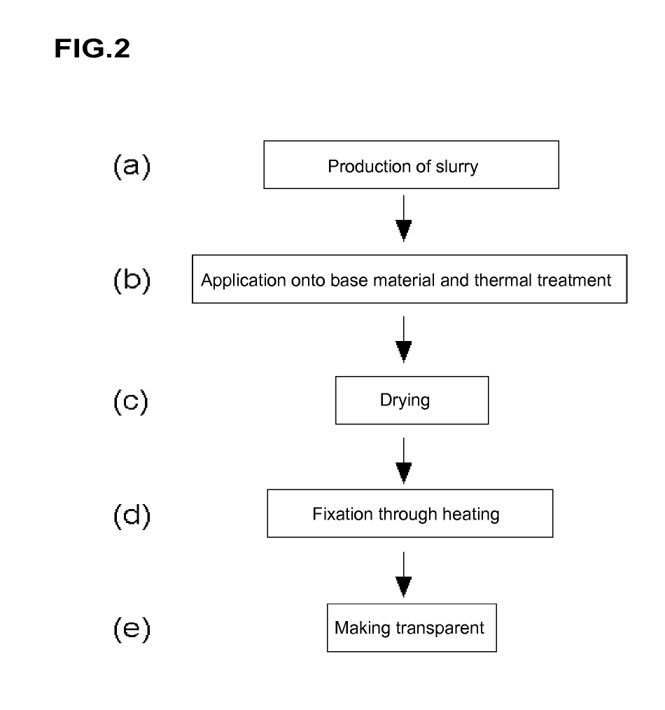

In the present invention, the silica coating formed on the surface of the base material may be further heated to make at least a portion of the silica coating transparent, to thereby provide a transparent silica glass layer (the second embodiment). FIG. 2 illustrates an outline of this embodiment.

First, as illustrated by (a) to (d) in FIG. 2, in the second embodiment the same steps as the steps a to d in the first embodiment are performed. In addition, the steps b to d or the steps b and c may be repeatedly performed as described above. After that, as illustrated by (e) in FIG. 2, the silica coating formed on the surface of the base material is further heated to make at least a portion of the silica coating transparent, to thereby provide a transparent silica glass layer (step e).

The silica coating may be made transparent by a surface heating method using oxyhydrogen flame melting, propane flame melting, arc melting, electric melting, or the like. When only the surface of the silica coating is to be heated, it is necessary to appropriately adjust a temperature (the temperature of flame in the case of the flame melting) or a distance between the surface and the flame because of local heating. It should be noted that, in this case, a surface portion of the silica coating to be served as the transparent silica glass layer is preferably a region of from the surface to a depth of at least 0.05 mm. A transparent silica glass layer having such thickness can achieve the above-mentioned effects in a short operation time and at a low cost.

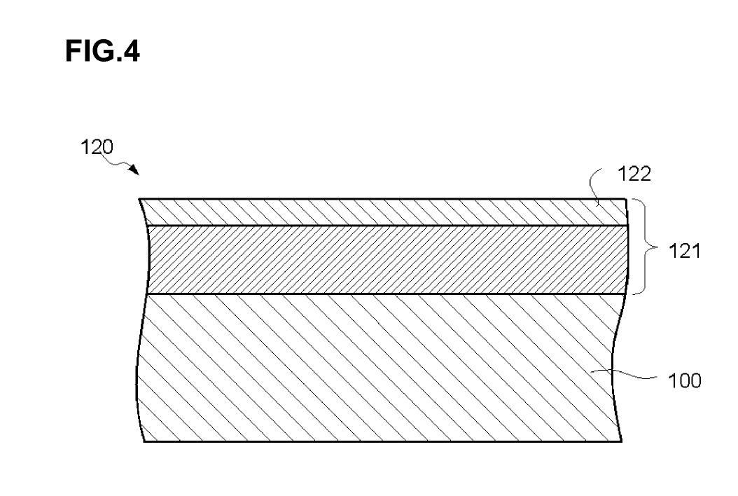

When only the surface portion of the silica coating is made transparent, a silica-coated body 120 as illustrated in FIG. 4 can be obtained. The silica-coated body 120 includes a transparent silica glass layer 122 in the surface of a silica coating 121. Such silica-coated body 120 can be used in applications in which surface exposure of the silica glass particles in the silica coating 121 is not preferred. That is, by including the transparent silica glass layer in the surface of the silica coating, generation of particles or emission of impurity gas molecules from the silica coating can be prevented. With regard to the emission of impurity gas molecules, the total number of molecules of desorption gas to be emitted from the transparent silica glass layer 122 can be set to 1×10¹⁵ molecules/g or less through formation of the transparent silica glass layer 122 in the surface of the silica coating 121, and thus, the emission of impurity gas molecules from the underlying silica coating can be prevented.

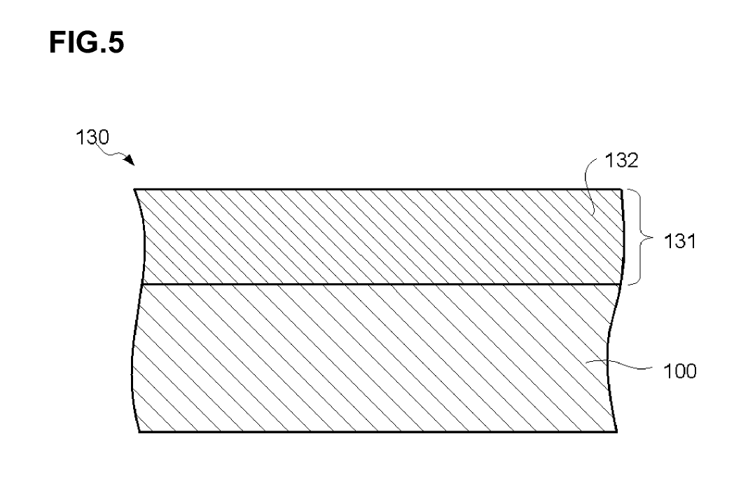

In addition, the entirety of the silica coating may be made transparent, to provide the transparent silica glass layer. In this case, as illustrated in FIG. 5, in a silica-coated body 130, the entirety of a silica coating 131 on the surface of the base material 100 is a transparent silica glass layer 132. When the material of the base material 100 is silica glass, the silica coating 131 may be integrated with the base material 100.

In addition, in the present invention, the material of the base material may be black silica glass, and the silica coating formed on the surface of the base material may be a non-transparent silica glass layer.

### EXAMPLES

Hereinafter, the present invention is described in more detail by way of Examples of the present invention and Comparative Examples. However, the present invention is not limited thereto.

### Example 1

Synthetic silica glass particles having an average particle size of 5 μm were dispersed in an aqueous solution containing 1% of methyl cellulose. Thus, a slurry having a solid content concentration of 50% was obtained.

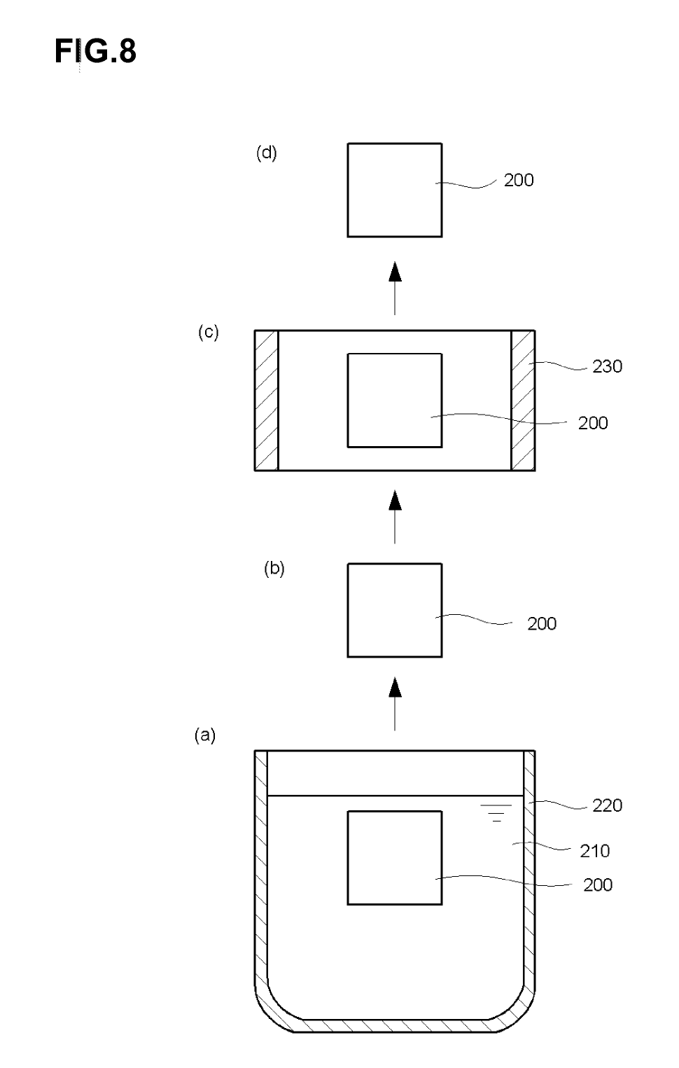

A gel coating was formed on the surface of a natural quartz glass plate (base material) of 30 mm square by using the slurry as described below. A description is given with reference to FIG. 8. A natural quartz glass plate 200 was dipped into the slurry 210 contained in a slurry container 220 ((a) in FIG. 8). The natural quartz glass plate 200 was pulled up from the slurry 210, and thus, an applied coating was formed on the surface of the natural quartz glass plate 200 ((b) in FIG. 8). At the time of the pulling, the natural quartz glass plate 200 was allowed to pass through a heated box (means for thermal treatment) 230. Thus, the applied coating was heated ((c) in FIG. 8), and the slurry was gelled ((d) in FIG. 8).

After that, the gel coating was dried, and thus, the natural quartz glass plate having a surface coated with a silica particle layer was obtained. The resultant was heated at 1,000° C. for 5 hours under the atmosphere. Thus, the natural quartz glass plate coated with a silica coating having a thickness of about 200 μm was obtained. By SEM observation, it was confirmed that in the silica coating the silica glass particles were immobilized.

### Example 2

A silica-coated body (a natural quartz glass plate coated with a silica coating in which silica glass particles were immobilized) obtained by the same method as in Example 1 was heated at 1,400° C. for 1 hour under the atmosphere. By this, the entirety of the silica coating was made transparent to provide a transparent silica glass layer. The thickness of the resultant transparent silica glass layer was about 150 μm, and thus, silica glass in which the natural quartz glass plate served as the base material and the transparent silica glass layer were integrated was obtained.

### Example 3

Synthetic silica glass particles having an average particle size of 5 μm were dispersed in an aqueous solution containing 1% of agar. Thus, a slurry having a solid content concentration of 50% was obtained. A natural quartz glass plate of 30 mm square as a base material was dipped into the slurry, and was pulled up from the slurry. Thus, an applied coating was formed on the surface of the natural quartz glass plate. At the time of the pulling, the natural quartz glass plate was allowed to pass through a cooled box. Thus, the applied coating was cooled, and the slurry was gelled. After that, the resultant gel coating was dried, and thus, the natural quartz glass plate having a surface coated with a silica particle layer was obtained. The resultant was heated at 1,000° C. for 5 hours under the atmosphere. Thus, the natural quartz glass plate coated with a silica coating having a thickness of about 200 μm was obtained. By SEM observation, it was confirmed that in the silica coating the silica glass particles were immobilized.

### Example 4

Synthetic silica glass particles having an average particle size of 100 nm were dispersed in an aqueous solution containing 1% of methyl cellulose. Thus, a slurry having a solid content concentration of 40% was obtained. A natural quartz glass plate of 30 mm square as a base material was dipped into the slurry, and was pulled up from the slurry. Thus, an applied coating was formed on the surface of the natural quartz glass plate. At the time of the pulling, the natural quartz glass plate was allowed to pass through a heated box. Thus, the applied coating was heated, and the slurry was gelled. After that, the resultant gel coating was dried, and thus, the natural quartz glass plate having a surface coated with a silica particle layer was obtained. The above-mentioned steps were repeated three times. After that, the resultant was heated at 1,000° C. for 5 hours under the atmosphere. Thus, the natural quartz glass plate coated with a silica coating having a thickness of about 0.6 mm was obtained. As a result of SEM observation, it was found that in the silica coating the silica glass particles were immobilized, and a particle density thereof was about 1.2×10¹⁵ particles/cm³. In addition, as a result of desorption gas analysis up to 1,000° C., it was found that the total number of molecules of desorption gas up to 1,000° C. in terms of hydrogen, water, oxygen, and carbon dioxide was about 7×10²⁰ molecules/g. In addition, it was found that the silica coating had an absolute diffuse light reflectance of 85% in a wavelength range of from 200 nm to 5,000 nm.

### Example 5

About 1 kg of a column-shaped quartz glass porous body (concentration of hydroxyl group: 1,000 ppm) having a diameter of 100 mm, obtained through deposition of a plurality of quartz glass layers by flame hydrolysis of tetrachlorosilane, was placed in a furnace core pipe (diameter: 200 mm) made of quartz glass provided in an electric furnace. Next, the furnace core pipe was evacuated. Then, the quartz glass porous body was heated to 500° C., and subjected to pre-heating at the temperature for 60 minutes. After that, the temperature was increased to a reaction temperature, and gas steam of hexamethyldisilazane as a reaction gas was supplied while being diluted with N₂ gas to be reacted with hydroxyl groups in the porous body. The heating was performed at a reaction temperature of 400° C. for a reaction time period of 10 hours and the reaction temperature was maintained for the reaction time period. It should be noted that the flow rate of the N₂ gas was 1 mol/hr.

After the completion of the reaction, the treated porous body was moved to a heating furnace, followed by sintering at a pressure of 0.001 MPa and a temperature of 1,500° C. in N₂ gas for 1 hour. Thus, a black synthetic quartz glass body was obtained.

The obtained black synthetic quartz glass having a transparent layer was measured as described below.

The light transmittance of a black portion at a thickness of 1 mm was measured in a wavelength range of from 200 to 10,000 nm. In addition, a black portion and a transparent portion were each measured for the contents of Li, Na, K, Mg, Ti, Fe, Cu, Ni, Cr, and Al by ICP mass spectrometry, and the total content of those metals was determined. The content of OH group was calculated through measurement of absorption specific to the group in an infrared region by FTIR. A transparent layer portion and a black quartz portion of the obtained black synthetic quartz glass having a transparent layer were each measured for the content of carbon (C) by an infrared absorption method after combustion. Further, the viscosities (unit: poise) at 1,280° C. of those portions were confirmed by heating those portions to 1,280° C. and using a beam bending method.

It was found that the black silica glass had a light transmittance of from 0 to 10% in a wavelength range of from 200 to 10,000 nm at a thickness of 1 mm, a total concentration of the metal impurities of 0.1 ppm, a carbon concentration of 400 ppm, an OH group concentration of less than 1 ppm, and a viscosity of log η=12.0 at 1,280° C.

A plate of 20×5×50 mm was cut out from the obtained black synthetic quartz glass body, and degreased with ethyl alcohol while its surface was maintained in the state of having been cut, followed by washing with pure water. After that, a black synthetic silica glass having a surface coated with a silica coating having a thickness of about 0.3 mm was obtained by using a silica slurry produced in the same manner as in Example 4 except that synthetic silica glass particles having an average particle size of 5 μm were used.

As a result of SEM observation, it was found that in the silica coating the silica glass particles were immobilized, and a particle density thereof was about 1.1×10¹⁰ particles/cm³. In addition, as a result of desorption gas analysis of the silica coating up to 1,000° C., it was found that the total number of molecules of desorption gas up to 1,000° C. in terms of hydrogen, water, oxygen, and carbon dioxide was about 4×10¹⁸ molecules/g. In addition, it was found that the silica coating had an absolute diffuse light reflectance of 63% in a wavelength range of from 200 nm to 5,000 nm. As compared to Example 4, the silica glass particles had a large average particle size, and hence, the particle density was low. In consequence, the reflectance became low.

### Example 6

A natural quartz glass plate coated with a silica coating having a thickness of about 0.6 mm was obtained by the same method as in Example 4. For the obtained natural quartz glass plate, heating was performed on the surface of the silica coating by using oxyhydrogen flame while the degree of progress of melting was checked. Thus, a silica-coated body in which the portion from the surface to a depth of about 0.06 mm was made transparent (a non-transparent silica-coated body having a transparent layer) was obtained. It should be noted that, of the silica coating, the portion under the transparent silica glass layer was a non-transparent layer that went from a semi-transparent layer to a particle deposition layer.

As a result of desorption gas analysis of the transparent silica glass layer up to 1,000° C., it was found that the total number of molecules of desorption gas up to 1,000° C. in terms of hydrogen, water, oxygen, and carbon dioxide was about 1×10¹⁵ molecules/g.

### Example 7

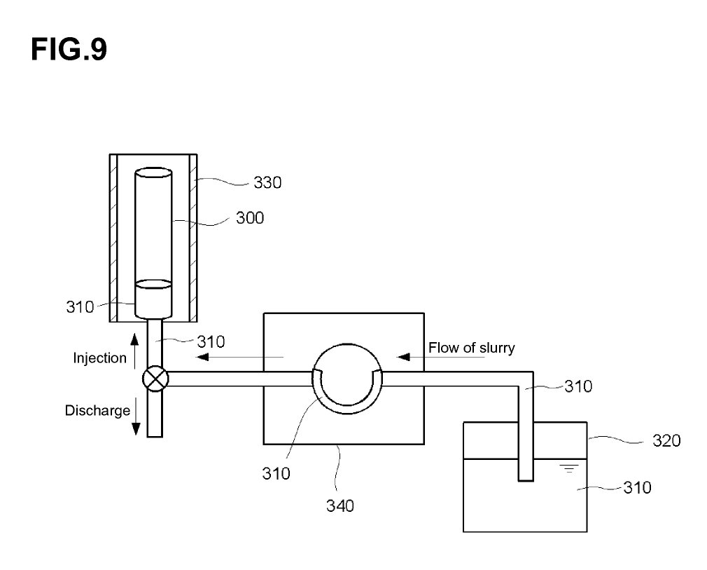

The same slurry as that in Example 1 was produced. A gel coating was formed on the inside of a silica glass tube (tubular base material) having a length of 1 m and an inner diameter of 7 mm by using the slurry as described below. The formation is described with reference to FIG. 9. The slurry 310 was charged in a slurry container 320. The slurry 310 was poured (injected) into the inside of the silica glass tube 300 by using a pump 340, and then, the slurry 310 was discharged therefrom. During this time, the pouring and discharging of the slurry 310 were performed while heating was performed from the outside of the silica glass tube 300 by using means for thermal treatment 330. Thus, the gel coating obtained through gelation of the slurry 310 was formed on the inner wall of the silica glass tube 300.

After that, the gel coating was dried, and then, the resultant was heated at 1,000° C. for 5 hours under the atmosphere. Thus, the silica glass tube having an inner wall coated with a silica coating having an almost uniform thickness of about 60 μm was obtained. By SEM observation, it was confirmed that in the silica coating the silica glass particles were immobilized.

### Comparative Example 1

The same procedure as that in Example 1 was employed except that an aqueous solution containing 1% of polyvinyl alcohol was used instead of the aqueous solution containing 1% of methyl cellulose. As a result, the natural quartz glass plate coated with a silica coating (silica particle deposition coating) having a thickness of about 10 μm was obtained, because polyvinyl alcohol did not exhibit a gelling effect. In addition, the thickness varied with place.

It should be noted that the present invention is not limited to the embodiments described above. The embodiments are given only for illustrative purposes, and any other embodiment that has a configuration substantially the same as the technical concept described in the claims of the present invention and exhibits similar actions and effects is included in the technical scope of the present invention.

### REFERENCE SIGNS LIST

100: base material, 110: silica-coated body, 111: silica coating, 120: silica-coated body, 121: silica coating, 122: transparent silica glass layer, 130: silica-coated body, 131: silica coating, 132: transparent silica glass layer, 200: natural quartz glass plate (base material), 210: slurry, 220: slurry container, 230: means for thermal treatment, 300: silica glass tube (tubular base material), 310 slurry, 320: slurry container, 330: means for thermal treatment, 340: pump.

What is claimed is:

1. A coating method for a surface of a base material with a silica coating, the method comprising at least:
adding silica glass particles and an organic material capable of gelling by a thermal factor in an aqueous solution to water to produce a slurry;
applying the slurry onto the surface of the base material to form an applied coating, followed by subjecting the applied coating to thermal treatment, to thereby obtain a gel coating;
drying the gel coating to provide a silica particle layer; and
heating the silica particle layer to fix the silica particle layer onto the surface of the base material, to thereby provide a silica coating.

2. A coating method with a silica coating according to claim 1, wherein a material of the base material comprises silica glass.

3. A coating method with a silica coating according to claim 2, wherein the silica glass comprises black silica glass.

4. A coating method with a silica coating according to claim 1, wherein the organic material capable of gelling by a thermal factor comprises methyl cellulose.

5. A coating method with a silica coating according to claim 1, wherein the organic material capable of gelling by a thermal factor comprises agar.

6. A coating method with a silica coating according to claim 1, wherein the silica glass particles to be contained in the slurry have an average particle size of from 5 nm to 5 μm.

7. A coating method with a silica coating according to claim 1, wherein the base material has a tubular shape and the silica coating is formed on an inner wall of the tubular base material.

8. A coating method with a silica coating according to claim 1, further comprising heating the silica coating formed on the surface of the base material to make at least a surface portion of the silica coating transparent, to thereby provide a transparent silica glass layer.

9. A coating method with a silica coating according to claim 8, wherein the surface portion of the silica coating to be served as the transparent silica glass layer comprises a region from a surface to a depth of at least 0.05 mm.

10. A coating method with a silica coating according to claim 8, wherein the heating is performed so that an entirety of the silica coating is made transparent, to thereby provide the transparent silica glass layer.

11. A production method for a silica-coated body, the method comprising coating the surface of the base material with a silica coating by the coating method with a silica coating according to claim 1.

12. A silica-coated body, comprising:
a base material; and
a silica coating formed on a surface of the base material, wherein:
the silica coating comprises silica glass particles each having a size of from 50 nm to 300 nm at a density of 9×10¹² particles/cm³ or more; and
the silica coating has an absolute diffuse light reflectance of 30% or more in a wavelength range of from 200 nm to 5,000 nm.

13. A silica-coated body according to claim 12, wherein a material of the base material comprises silica glass.

14. A silica-coated body according to claim 13, wherein the silica glass comprises black silica glass.

15. A silica-coated body according to claim 14, wherein the black silica glass has a light transmittance of 10% or less in a range of from 200 to 10,000 nm at a thickness of 1 mm, has a total concentration of metal impurities of 1 ppm or less, has a carbon concentration of more than 30 ppm and 50,000 ppm or less, has an OH group concentration of 1 ppm or less, and has a viscosity of 10^{11.7} poise or more at 1,280° C.

16. A silica-coated body according to claim 12, wherein the silica coating has a thickness of 0.5 mm or more.

17. A silica-coated body according to claim 12, wherein the silica coating has a total number of molecules of desorption gas up to 1,000° C. in terms of hydrogen, water, oxygen, and carbon dioxide of 1×10²³ molecules/g or less.

18. A silica-coated body according to claim 12, wherein the silica coating has a transparent silica glass layer in a surface thereof.

19. A silica-coated body according to claim 18, wherein the transparent silica glass layer has a thickness of 0.05 mm or more.

20. A silica-coated body according to claim 18, wherein the transparent silica glass layer has a total number of molecules of desorption gas up to 1,000° C. in terms of hydrogen, water, oxygen, and carbon dioxide of 1×10¹⁵ molecules/g or less.
